(19) United States
(12) Patent Application Publication
(10) Pub. No.: US 2026/0214390 A1
(43) Pub. Date: Jul. 23, 2026

(54) SOUND PRODUCTION UNIT AND AUDIO DEVICE

(71) Applicant: CALDRON TECHNOLOGIES PTE. LTD., Singapore (SG)

(72) Inventors: Hao LI, Singapore (SG); Quan YUAN, Singapore (SG); Qian LIU, Singapore (SG)

(73) Assignee: CALDRON TECHNOLOGIES PTE. LTD., Singapore (SG)

(21) Appl. No.: 19/143,805

(22) PCT Filed: Dec. 21, 2023
(86) PCT No.: PCT/CN2023/140458

§ 371 Date: Jun. 26, 2025

(30) Foreign Application Priority Data
Dec. 27, 2022 (CN) 202211688858.2
Dec. 27, 2022 (CN) 202211688859.7
Dec. 27, 2022 (CN) 202223503563.1
Dec. 27, 2022 (CN) 202223548590.0
Jun. 27, 2023 (CN) 202310763758.X
Jun. 27, 2023 (CN) 202321659307.3

(51) Int. Cl. H04R 13/00; H04R 1/02; H04R 7/10; H04R 7/18

(52) U.S. Cl. CPC H04R 13/00; H04R 1/025; H04R 7/10; H04R 7/18

(57) ABSTRACT

The embodiments of the present disclosure provide a sound production unit and an audio device, the sound production unit production comprises: at least one pair of magnets, wherein each pair of magnets are arranged opposite to each other with the same poles, and there is an opposing gap between each pair of magnets; an insulating film, inserted into the opposing gap, wherein each pair of magnets are symmetrically distributed on two sides of the insulating film; a conductor, arranged on the insulating film and located in the opposing gap; when the conductor vibrates at a high frequency, the conductor vibrates and produces sound; when the conductor vibrates at a low frequency, the conductor drives the entire insulating film to vibrate and produce sound.

### TECHNICAL FIELD

The present disclosure relates to the technical field of sound production device, and in particular to a sound production unit and an audio device.

### BACKGROUND

With the development of technology, a ribbon speaker has become popular among users because it produces more realistic and pure high frequencies with less distortion. The principle is to apply audio current to a conductive film placed in a uniform magnetic field. When the energized conductive film passes through the magnetic field, it will be affected by the magnetic field force. By changing the direction and magnitude of the audio current, the direction and magnitude of the magnetic field force acting on the conductive film are also changed. In this way, the conductive film will vibrate at a certain frequency under the action of the magnetic field force, thereby making the conductive film emit sound.

However, the sound waves emitted by the vibration of the conductive film will produce diffraction at the edge of the conductive film, causing some of the sound waves to cancel each other out. Since bass is more likely to diffract during propagation, the bass will cancel out more. As a result, when the conductive film vibrates and produces sound, the sound pressure level (SPL curve) from bass to high is not smooth. Therefore, in the design of some audio systems, ribbon speakers are chosen as the high-frequency element, and other low-frequency sound apparatus are added to enhance the bass effect. This will make the entire design complicated and increase the number of sound elements. Sound elements of different materials have different timbres, which will make it difficult to maintain the same timbre in the entire frequency domain, reducing the user experience of the audio system. At the same time, due to the existence of the cabinet, traditional audio loses its most authentic and pure sound. Furthermore, traditional speakers can be regarded as surface sound sources when the paper cone or diaphragm film produces sound, especially traditional electrostatic speakers, which are driven by a huge electrostatic panel to vibrate the entire film to produce sound. The sound produced by such a surface sound source is directional, and the frequency response of the speaker is different at different angles away from the axis. Generally, the greater the angle away from the axis, the more the high frequency is attenuated, which greatly affects the smoothness of the SPL (Sound Pressure Level) curve.

### SUMMARY

In view of the above problems, the present disclosure is proposed to provide a sound production unit and an audio device that solve the above problems.

One embodiment of the present disclosure provides a sound production unit, including:
at least one pair of magnets, wherein each pair of magnets are arranged opposite to each other with the same poles, and there is an opposing gap between each pair of magnets;
an insulating film, inserted into the opposing gap, wherein each pair of magnets are symmetrically distributed on two sides of the insulating film;
a conductor, arranged on the insulating film and located in the opposing gap;
where, when the conductor vibrates at a high frequency, the conductor vibrates and produces sound; when the conductor vibrates at a low frequency, the conductor drives the entire insulating film to vibrate and produce sound.

Optionally, the conductor is bonded to the insulating film by gluing.

Optionally, a rib structure is further included;
the rib structure is penetrated on the insulating film and is used to drive the insulating film to vibrate together when the conductor vibrates.

Optionally, the rib structure comprises: a rib group extending in at least one direction;
the rib group comprises a plurality of ribs arranged at intervals.

Optionally, the rib comprises one of carbon fiber material, metal material, plastic material, wood material, and polymer material;

Optionally, the rib is a convex rib structure formed by bending the insulating film;
or, the rib structure is integrally formed on the insulating film when the insulating film is prepared.

Optionally, the conductor is a conductive wire;
or, the conductor is a conductive film.

Optionally, an elastic suspension component is further included, one end of the elastic suspension component is connected to the insulating film, and the other end is connected to the magnet or a shell of the sound production unit.

Optionally, the elastic suspension component is arranged on one side of the insulating film;
or, the two sides of the insulating film are provided with the elastic suspension component.

Optionally, the elastic suspension component comprises a plurality of elastic pieces, and the plurality of elastic pieces are arranged along a length direction of the insulating film.

Optionally, the elastic piece comprises one of a linear structure, an M-shaped structure, a V-shaped structure, a C-shaped structure, an arc structure, a wavy structure, a sawtooth structure, a spiral linear structure and a ring structure.

Another embodiment of the present disclosure provides a sound production unit, including:
at least one pair of magnets, wherein each pair of magnets are arranged opposite to each other with the same poles, and there is an opposing gap between each pair of magnets;
an insulating film, inserted into the opposing gap, wherein each pair of magnets are symmetrically distributed on two sides of the insulating film;
a conductor, arranged on the insulating film to form a diaphragm film, wherein the conductor is located in the opposing gap;
where, the conductor is an active sound production part of the sound production unit; when current flows through the conductor, the active sound production part drives the insulating film to vibrate and produce sound.

Optionally, the conductor is bonded to a first surface of the insulating film;
or, different conductors are bonded to a first surface and a second surface of the insulating film respectively;
the conductor is bonded to the insulating film by gluing.

Optionally,
multiple layers of the insulating films and multiple layers of the conductors are laminated and bonded to form a whole, and conductive circuits located in different layers are electrically connected to each other.

Optionally, an elastic suspension component is further included, one end of the elastic suspension component is connected to the insulating film, and the other end is connected to the magnet or a shell of the sound production unit.

Optionally, the elastic suspension component is connected to the first surface of the insulating film;
or, the first surface and the second surface of the insulating film are both connected to the elastic suspension component.

Optionally, a supporting structure is formed by bending at an edge of the insulating film, and the supporting structure is the elastic suspension component.

Optionally, the elastic suspension component is connected to two side edges of the insulating film respectively;
or, four side edges of the insulating film are all connected to the elastic suspension component.

Still another embodiment of the present disclosure provides an audio device, including a shell and a sound production unit;
the sound production unit is arranged on the shell.

The technical solution provided in the embodiment of the present disclosure, by providing a rib structure on the insulating film, allows the conductor to only drive part of the insulating film to vibrate during high-frequency vibration, and drive the entire insulating film to vibrate during low-frequency vibration, thereby providing partial gain compensation for the low-frequency sound and ensuring that the sound pressure level of the sound production unit is stable over the entire sound range when emitting low-frequency and high-frequency sounds.

The present disclosure provides an audio box, including:
a shell, having an inner cavity with an opening;
an inverted tube component, arranged in the inner cavity, wherein a first end faces the opening of the inner cavity, a second end communicates with an outside of the shell, and an echo hole is formed on a surface of the shell;
a closed tube component, having a first open end and a second closed end, wherein the first open end faces the opening of the inner cavity, and the second closed end is arranged in the inner cavity;
where, the opening of the inner cavity is able to be provided with a sound production unit, one side of a diaphragm film of the sound production unit faces the inner cavity; a reverse sound wave produced by the diaphragm film diffuses into the inverted tube component and the closed tube component, and a part of the reverse sound wave is transmitted out from the echo hole, while the other part of the reverse sound wave is absorbed by the closed tube component.

Optionally, the inverted tube component includes a plurality of inverted tubes, and different inverted tubes have different lengths.

Optionally, the inverted tube extends from the opening of the inner cavity to one side of the shell;
or, the inverted tube is in a reciprocating bending shape and extends from the opening of the inner cavity to one side of the shell.

Optionally, the closed tube component includes a plurality of closed tubes, and different closed tubes have different lengths.

Optionally, the closed tube extends from the opening of the inner cavity to the inner cavity of the shell;
or, the closed tube extends from the opening of the inner cavity to the inner cavity of the shell in a reciprocating bending shape.

Optionally, cross-sectional shapes of the inverted tube and the closed tube in the closed tube component are the same;
or, cross-sectional shapes of the plurality of inverted tubes or the plurality of closed tubes respectively comprise at least two different cross-sectional shapes;
the cross-sectional shapes comprise: square, circle, triangle and polygon.

Optionally, the cross-sectional shape of the shell comprises one of: square, circular and polygonal.

Still another embodiment of the present disclosure provides an audio device, including said audio box and at least one sound production unit;
the sound production unit is arranged at an opening of the shell,
the sound production unit and the inverted tube component are arranged at intervals, and a sound guide cavity is formed between the inverted tube component and the sound production unit.

One embodiment of the present disclosure provides an audio box, including:
a shell, having an inner cavity with an opening;
a closed tube component, having a first open end and a second closed end, wherein the first open end faces the opening of the inner cavity, and the second closed end is arranged in the inner cavity;
where, the opening of the inner cavity is able to be provided with a sound production unit, one side of a diaphragm film of the sound production unit faces the inner cavity; a forward sound wave produced by the diaphragm film diffuses outward from the inner cavity, and a reverse sound wave produced by the diaphragm film diffuses into the closed tube component, and a part of the reverse sound wave is absorbed by the closed tube component.

Optionally, an inverted tube component is further included;
the inverted tube component is arranged in the inner cavity, a first end faces the opening of the inner cavity, a second end communicates with an outside of the shell, an echo hole is formed on a surface of the shell, the reverse sound wave produced by the diaphragm film diffuses into the inverted tube component, and a part of the reverse sound wave is transmitted out from the echo hole.

Optionally, the inverted tube component comprises a plurality of inverted tubes, and different inverted tubes have different lengths;
the closed tube component comprises a plurality of closed tubes, and different closed tubes have different lengths.

Still another embodiment of the present disclosure provides an audio system, including a controller and a plurality of said audio devices;
where the controller is electrically connected to the plurality of audio devices respectively.

The technical solution provided by the embodiment of the present disclosure, in the technical solution provided by the present disclosure, by providing an inverted tube component and a closed tube component in the sound cavity, the inverted tube component can invert the sound waves of multiple frequency bands, so that the phase of the reverse sound wave is the same as the phase of the forward sound wave, and is superimposed on the forward sound wave, thereby increasing the efficiency of the forward sound wave. The closed tube component can absorb part of the sound waves in multiple frequency bands of the reverse sound waves, which on the one hand greatly reduces the volume of the speaker, and on the other hand can reduce the sound distortion caused by the box not absorbing sound, making the sound effect of the audio device better, and also can make the frequency response curve of the audio device approach a more stable state.

### BRIEF DESCRIPTION OF THE DRAWINGS

In order to describe the embodiments of the present disclosure or the technical solutions in the prior art more clearly, drawings required to be used in the embodiments or the description of the prior art will be briefly introduced below. Apparently, the drawings in the description below are some embodiments of the present disclosure. Those of ordinary skill in the art may also obtain other drawings according to the provided drawings without involving any inventive effort.

FIG. 1 is a front-view schematic diagram of a first sound production unit provided in an embodiment of the present disclosure;

FIG. 2 is a left-view schematic diagram of the first sound production unit provided in an embodiment of the present disclosure;

FIG. 3 is a schematic diagram of the magnetic field distribution of opposing magnets provided in an embodiment of the present disclosure;

FIG. 4 is a front-view schematic diagram of a second sound production unit provided in an embodiment of the present disclosure;

FIG. 5 is a top-view of a diaphragm film provided in an embodiment of the present disclosure;

FIG. 6 is a front-view schematic diagram of a third sound production unit provided in an embodiment of the present disclosure;

FIG. 7 is a front-view schematic diagram of a fourth sound production unit provided in an embodiment of the present disclosure;

FIG. 8 is a front-view schematic diagram of a fifth sound production unit provided in an embodiment of the present disclosure;

FIG. 9 is a partial front-view schematic diagram of a sixth sound production unit provided in an embodiment of the present disclosure;

FIG. 10 is a partial front-view schematic diagram of a seventh sound production unit provided in an embodiment of the present disclosure;

FIG. 11 is a partial top-view schematic diagram of an eighth sound production unit provided in an embodiment of the present disclosure;

FIG. 12 is a partial top-view schematic diagram of a ninth sound production unit provided in an embodiment of the present disclosure;

FIG. 13 is a partial top-view schematic diagram of a tenth sound production unit provided in an embodiment of the present disclosure;

FIG. 14 is a partial top-view schematic diagram of an eleventh sound production unit provided in an embodiment of the present disclosure;

FIG. 15 is a partial front-view schematic diagram of a twelfth sound production unit provided in an embodiment of the present disclosure;

FIG. 16 is a partial front-view schematic diagram of a thirteenth sound production unit provided in an embodiment of the present disclosure;

FIG. 17 is a schematic diagram of different listening angles of a conventional audio device;

FIG. 18 is a frequency response curve diagram corresponding to different listening angles of a conventional audio device;

FIG. 19 is a frequency response curve diagram corresponding to different listening angles of an audio device provided in an embodiment of the present disclosure;

FIG. 20 is a three-dimensional schematic diagram of an audio box shell provided in an embodiment of the present disclosure;

FIG. 21 is a front-view of an audio box shell provided in an embodiment of the present disclosure;

FIG. 22 is a half-section three-dimensional structural diagram of a sound box shell provided in an embodiment of the present disclosure;

FIG. 23 is a three-dimensional structural diagram of an audio box shell provided by an embodiment of the present disclosure from another perspective;

FIG. 24 is a rear-view of an audio box shell provided in an embodiment of the present disclosure;

FIG. 25 is a half-section three-dimensional structural diagram of another audio box shell provided in an embodiment of the present disclosure; and

FIG. 26 is a half-section front-view of another audio box shell provided in an embodiment of the present disclosure.

### DETAILED DESCRIPTION OF EXAMPLE EMBODIMENTS

The technical solutions in the embodiments of the present disclosure will be clearly and completely described below in conjunction with the drawings in the embodiments of the present disclosure. Obviously, the described embodiments are only part of the embodiments of the present disclosure, rather than all the embodiments. Based on the embodiments in the present disclosure, all other embodiments obtained by those skilled in the art without making any creative work shall fall within the scope of protection of the present disclosure. The term “including” mentioned throughout the specification and claims is an open-ended term and should be interpreted as “including but not limited to”. “Approximately” means that within an acceptable error range, those skilled in the art can solve the technical problem within a certain error range and basically achieve the technical effect. In addition, in the embodiments of the present disclosure, a plurality refers to two or more than two. Those skilled in the art may combine and associate different embodiments or examples and features of different embodiments or examples described in this specification without mutual contradiction.

We know that when the diaphragm film of a speaker vibrates at different frequencies, it can emit sounds of different frequencies. For example, when the diaphragm film vibrates at a high frequency, it can emit high-frequency sounds, and when the diaphragm film vibrates at a low frequency, it can emit low-frequency sounds. Since the ribbon speaker has no cabinet to separate the sound waves in front and behind the diaphragm film, the diaphragm film will produce diffraction when producing sound. The so-called diffraction phenomenon means that when the diaphragm film vibrates, sound waves are generated on both sides of the diaphragm film. When the sound waves on the back side of the diaphragm film are diffracted to the front side of the diaphragm film, they will cancel out the sound waves on the front side of the diaphragm film, thereby reducing the sound pressure level of the diaphragm film. Compared with high-frequency sounds, the diffraction phenomenon of low-frequency sounds is more serious, which will make the sound pressure level of low-frequency sounds obtained by the diaphragm film at the listening position lower than the sound pressure level of high-frequency sounds when the diaphragm film is making sounds, which will make the sound pressure level of the speaker unstable when making low-frequency and high-frequency sounds. In order to solve the above problems, the present disclosure provides a sound production unit and an audio device.

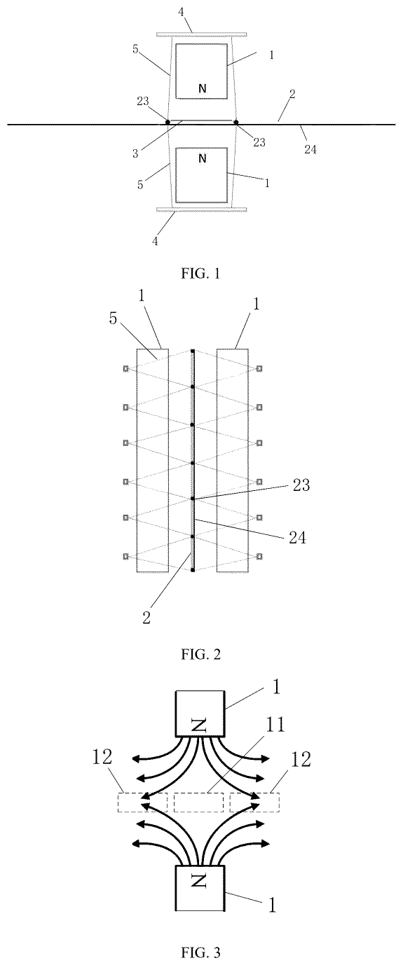

FIG. 1 is a schematic diagram of the front-view structure of the first sound production unit provided in an embodiment of the present disclosure, and FIG. 2 is a schematic diagram of the left-view structure of the first sound production unit provided in an embodiment of the present disclosure. Referring to FIGS. 1 and 2, in one embodiment of the present disclosure, a sound production unit is provided. The sound production unit includes: at least one pair of magnets 1, an insulating film 2, and a conductor 3. Each pair of magnets 1 is disposed opposite to each other with the same poles, and there is an opposing gap between each pair of magnets 1. Specifically, the magnet 1 usually has an N pole (North pole) and an S pole (South pole), and the same-pole opposition mentioned here means that the two magnets 1 are arranged opposite to each other, and the polarities of the opposite magnetic poles are the same. The opposing magnetic poles do not attach to each other, but have a certain gap to form an effective magnetic field. As shown in FIG. 3, when the same poles of two magnets 1 are facing each other, the magnetic fields of the two magnets 1 will influence each other, so that the magnetic fields of the two magnets 1 are concentrated in the opposing gap, and the direction of the magnetic field is biased to be approximately perpendicular to the magnets 1. This arrangement is conducive to concentrating the magnetic fields of the two magnets 1 in the opposing gap, thereby effectively improving the magnetic field strength at the opposing gap.

Referring to FIGS. 1 to 4, the insulating film 2 is passed through the opposing gaps, each pair of magnets 1 is symmetrically distributed on two sides of the insulating film 2, there is a certain gap between each magnet 1 and the insulating film 2, and the gaps between each magnet 1 and the insulating film 2 are the same size. The gaps between the two magnets 1 and the insulating film 2 together form an opposing gap. The conductor 3 is arranged on the insulating film 2 and is located in the opposing gap. When current passes through the conductor 3, the conductor 3 will be affected by the magnetic field force. When the current is an audio current of a certain frequency, the conductor 3 will also vibrate at a certain frequency. Since the conductor 3 and the insulating film 2 are adhesively connected, the insulating film 2 will be driven to vibrate when the conductor 3 vibrates, and the efficiency of driving the insulating film 2 to vibrate depends on the vibration frequency of the conductor 3. When the vibration frequency of the conductor 3 is high, the vibration amplitude transmitted to the insulating film 2 is smaller, that is, the area driving the insulating film 2 to vibrate is smaller. When the vibration frequency of the conductor 3 is low, the vibration amplitude driving the insulating film 2 is larger, that is, the area driving the insulating film 2 to vibrate is larger. The material of the insulating film 2 includes, but is not limited to: spandex mesh, butyl film, glass fiber film, carbon fiber cloth, nylon mesh, graphene, polymer film, and composite materials composed of various films. It should be noted that the insulating film 2 mentioned in the present disclosure is only the difference between insulation and non-insulation relative to the conductive part, and has nothing to do with whether the material itself is insulating. In a specific embodiment, the spandex mesh and glue can also be combined to form an insulating film 2. Specifically, the glue is applied to the entire surface of the spandex mesh to form a glue layer 21. The glue can not only bond the conductor to the spandex mesh, but also seal the holes on the spandex mesh to form a complete insulating film 2. In another specific embodiment, it may be a composite material film formed by laminating a butyl film and a thin aluminum film. Specifically, a butyl film is used as a base film and thin aluminum films are fully attached to both sides. Laser engraving technology is used to engrave a circuit, that is, the conductor 3, on the formed film. The film outside the circuit area is an insulating film 2. Although the material of the insulating film 2 in the present disclosure is a conductor, when the diaphragm film vibrates, there is no electricity in the insulating film 2. Therefore, the distinction between the insulating film 2 and the conductor 3 is mainly determined by whether it is energized, and does not directly indicate the material properties of the film.

It should be noted that, in the technical solution provided in the present disclosure, the conductor 3 is adhered to the first surface of the insulating film 2 (one surface of the insulating film). Alternatively, different conductors are respectively bonded to the first surface and the second surface of the insulating film, which can be understood as both the front and back surfaces of the insulating film 2 are provided with the conductor 3. Alternatively, the conductor 3 is provided inside the insulating film 2. In addition, the combination of the insulating film 2 and the conductor 3 can be regarded as a diaphragm film.

Further, referring to FIG. 1 to FIG. 4, in an embodiment provided in the present disclosure, the conductor 3 is bonded to the insulating film 2 by glue, and the glue has a certain viscoelasticity. In one case, when the conductor 3 vibrates at a high frequency, the amplitude of the conductor 3 under the high frequency vibration is small and the frequency is high. When the vibration is transmitted to the glue layer 21 formed by the adhesive glue, the energy is converted into heat energy in the glue layer and dissipated, so that the vibration cannot be transmitted to the insulating film. Therefore, in this case, the conductor 3 cannot drive the insulating film 2 to vibrate and make sound. In another case, when the conductor 3 vibrates at a relatively low frequency, the glue layer 21 cannot absorb the vibration in time due to the large amplitude and low frequency of the conductor 3, so that the conductor 3 can drive the insulating film 2 to vibrate and make sound. In this way, the diaphragm film surface that vibrates and produces sound becomes a combination of the insulating film 2 and the conductor 3.

In one embodiment provided in the present disclosure, the multi-layer insulating film 2 and the multi-layer conductor 3 are stacked and bonded together, and the conductors located in different layers are electrically connected to each other. Specifically, a plurality of insulating films 2 and a plurality of conductors 3 are stacked and bonded to form a diaphragm film, and conductors 3 of different layers are electrically connected to each other, and they may be connected in series or in parallel.

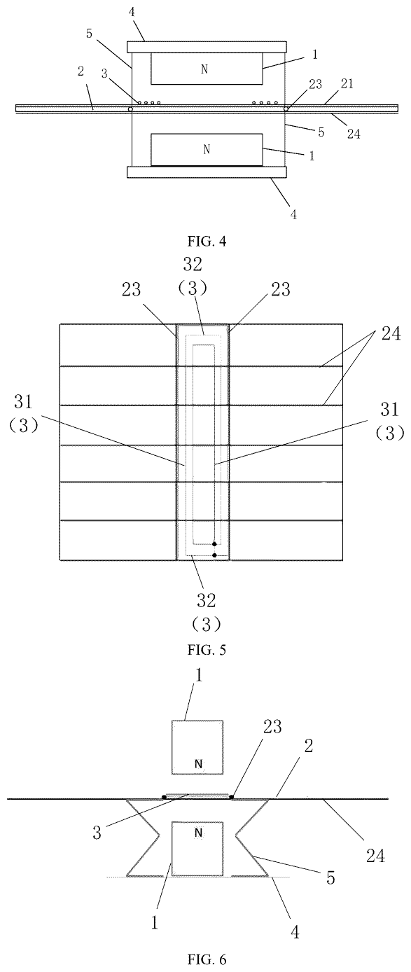

Referring to FIGS. 1 to 5, in one embodiment provided in the present disclosure, the conductor 3 may be a metal wire or a conductive film. The conductor 3 includes multiple sections of main circuits 31 and multiple sections of connection circuits 32. The multiple sections of connection circuits 32 sequentially connect multiple sections of main circuits 31 to form a complete circuit. A plurality of main circuits 31 are distributed at intervals on the insulating film 2 located in the opposing gap, and the connection circuits 32 are distributed on two end sides of the main circuits 31. The directions of the main circuit currents on different sides of the opposing gaps are opposite. For example, in FIG. 4, when current flows through the conductor 3, the direction of the current in the conductor 3 on the left is opposite to the direction of the current in the conductor 3 on the right. The present disclosure does not specifically limit the number of main circuits 31 on the insulating film, which can be set according to actual conditions. In addition, the main circuit 31 and the multi-section connection circuit 32 can be a complete conductive wire or conductive film, or can be formed by connecting multiple sections of conductive wires or conductive films, which is not limited in the present disclosure.

Furthermore, as shown in FIG. 2, due to the interaction between the opposing magnets 1 with the same poles, the magnetic field strength in the first region 12 in the opposing gap is greater than the magnetic field strength in the second region 11 of the opposing gap, and the magnetic field of the magnet 1 will form an effective magnetic field region on the insulating film passing through the opposing gap, and the effective magnetic field region is located within the first region 12. Therefore, by placing the main circuit 31 on the effective magnetic field region of the insulating film 2, the magnetic field effect on the main circuit 31 can be most effective. In a specific embodiment of the present disclosure, the conductor 3 is a metal wire, which is spirally arranged on the insulating film 2. The main circuit 31 of the metal wire is distributed in a straight line within the effective magnetic field area on the insulating film 2. The connection circuit 32 is arranged at both ends of the main circuit 31 to connect different main circuits 31. Then the metal wire conductor 3 is bonded to the insulating film 2 through the adhesive layer. When the metal wire vibrates at a high frequency, the glue layer can absorb the high-frequency and low-amplitude vibration, so only the metal wire vibrates and makes sound. When the metal wire vibrates at a low frequency, the glue layer cannot absorb the low-frequency and high-amplitude vibration. Therefore, the metal wire will also drive the insulating film to vibrate and make sound during the vibration process.

Furthermore, in another embodiment of the present disclosure, the conductor 3 is a conductive film. For example, a layer of conductor 3 material is adhered to the insulating film 2, and then a complete circuit is engraved by etching or laser engraving to form a conductive circuit.

For the insulating film 2 with a certain length and flexibility, although it can drive the insulating film 2 to vibrate and make sound when the conductor 3 vibrates at a low frequency, it can only drive the insulating film 2 near the conductor 3 to vibrate, and the conductor 3 cannot effectively drive the entire insulating film to vibrate and make sound. In order to obtain higher efficiency at low frequency vibration. In an embodiment provided in the present disclosure, referring to FIGS. 1, 4 and 5, the insulating film 2 also includes a rib structure, so that the entire flexible film needs to have a certain rigidity. In this way, under low-frequency conditions, the portion of the insulating film 2 that vibrates along with the conductor 3 can drive a larger area of the insulating film to vibrate together through the rib structure, thereby increasing the sound pressure level of the diaphragm film bass. In addition, the rib structure is penetrated on the insulating film, and can be arranged on the surface of the insulating film 2 or inside the insulating film 2.

In one embodiment provided in the present disclosure, the rib structure includes: a rib group extending along at least one direction, as shown in FIG. 5, the rib structure includes a transverse rib group and a longitudinal rib group, the transverse rib group and the longitudinal rib group are intertwined with each other, the extension direction of the transverse rib group is the same as the width direction of the insulating film 2, and the extension direction of the longitudinal rib group is the same as the length direction of the insulating film 2. The number of the rib groups extending along different directions on the insulating film 2 can be set according to actual conditions, and the present disclosure does not make any specific limitation. For example, in a specific embodiment, the insulating film 2 is provided with not only a transverse rib group and a longitudinal rib group but also a diagonal rib group, and the multiple rib groups are interwoven to form a mesh structure, thereby supporting the soft insulating film 2. In the technical solution provided in the present disclosure, the rib groups in multiple directions are interwoven with each other on the insulating film 2, so that the entire flexible insulating film 2 has a certain rigidity.

Furthermore, the rib group includes a plurality of ribs arranged at intervals. Referring to FIG. 5, in a specific embodiment, the transverse rib group includes a plurality of transverse ribs 24, and the plurality of transverse ribs 24 are arranged on the insulating film 2 at equal intervals. The longitudinal rib group includes two longitudinal ribs 23. The two longitudinal ribs 23 are respectively arranged on the insulating film 2, and the conductor 3 is arranged between the two longitudinal ribs 23. In the technical solution provided in the present disclosure, the rib includes one of carbon fiber materials, metal materials, plastic materials, wood materials, polymer materials, etc. As long as the material of the rib has a certain toughness and support and can support the entire insulating film 2, it can be used as the material for making the rib in the present disclosure.

In order to simplify the structure of the insulating film 2, in another embodiment provided in the present disclosure, the rib is a convex rib structure formed by bending the insulating film 2. Specifically, the insulating film 2 is folded to form a convex rib structure on the insulating film 2, and the convex rib structure will play a certain supporting role on the insulating film 2. The cross-sectional shape of the rib structure includes but is not limited to triangle, V-shape, W-shape, arc, circle, square and polygon. In another embodiment provided in the present disclosure, the rib structure is integrally formed on the insulating film 2 when the insulating film 2 is prepared.

In one embodiment provided in the present disclosure, in order to realize low-frequency vibration of the insulating film 2, a portion of the insulating film 2 near the conductor 3 drives the entire insulating film 2 to vibrate together. In addition to making the flexible insulating film 2 have a certain rigidity through the rib structure, in specific implementation, an insulating film 2 with a certain rigidity can also be used. For example, the insulating film 2 may be a hard structure with a certain toughness, including but not limited to: a carbon fiber sheet, a plastic sheet, a resin sheet, and a polymer composite sheet.

In order to fix the diaphragm film in the corresponding position and provide a certain restoring force when the diaphragm film vibrates, a sound production unit provided in the present disclosure also includes an elastic suspension component 5, one end of the elastic suspension component 5 is connected to the insulating film 2, and the other end is connected to the magnet 1 or the shell 4 of the sound production unit. Specifically, when the diaphragm film is vibrated by the magnetic field force and generates displacement, the elastic suspension component 5 is stretched. When the magnetic field force is removed, the restoring force generated by the elastic suspension component 5 enables the diaphragm film to return to its original position.

Referring to FIG. 6, in an embodiment provided in the present disclosure, the elastic suspension component 5 is arranged on one side of the insulating film 2. Specifically, the elastic suspension component 5 includes two symmetrically arranged elastic suspension pieces, and the two elastic suspension pieces are arranged on two sides of one of the magnets 1, one end of which is connected to the insulating film 2 and the other end is connected to the magnet 1, or is connected to the shell 4 connected to the magnet 1. One end connected to the insulating film 2 may be connected to the insulating film 2 or to the rib structure of the insulating film 2.

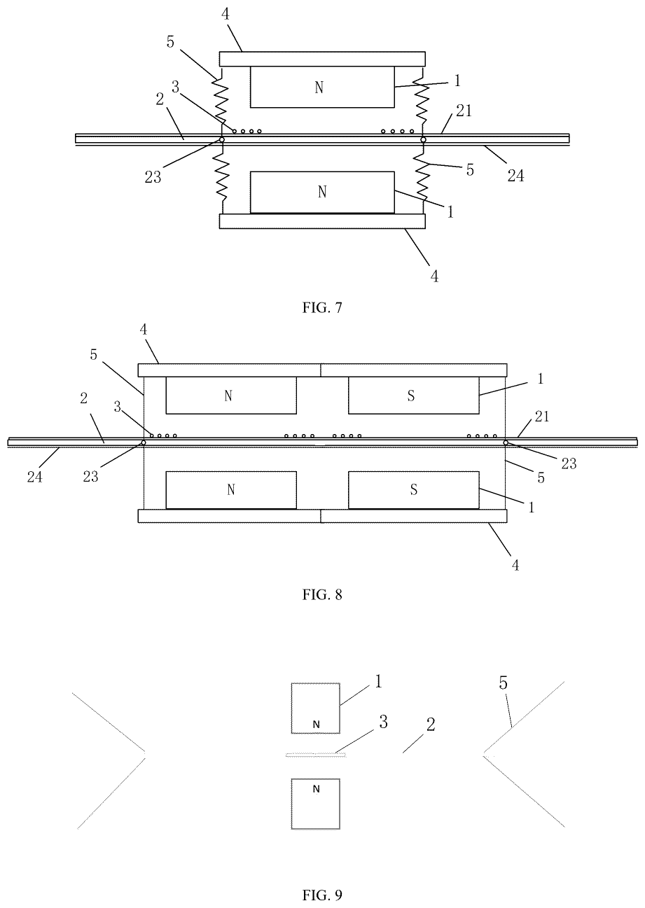

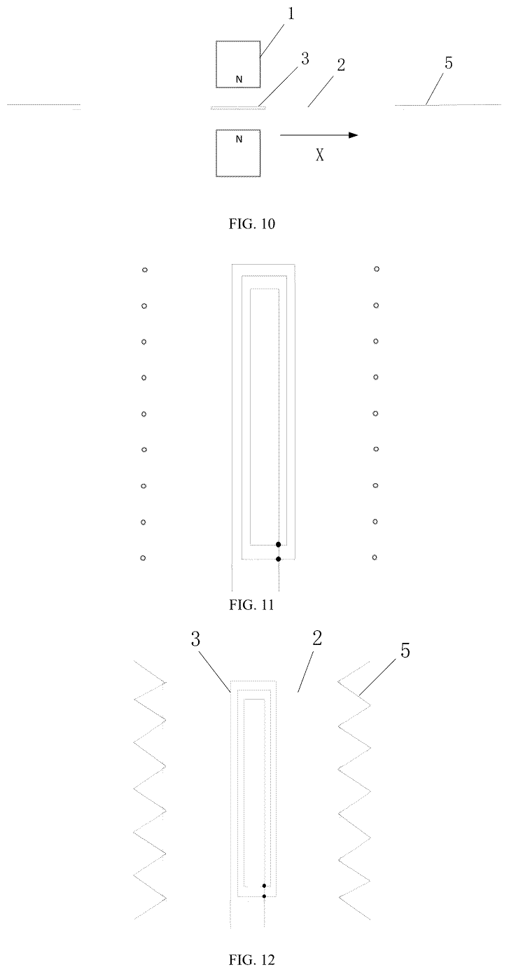

Referring to FIGS. 6 to 14, the elastic suspension component 5 has various specific implementations. The elastic suspension component 5 can be disposed on the surface of the insulating film 2 or on the side of the insulating film 2. For example, in FIG. 6, FIG. 7 and FIG. 10, the elastic suspension component 5 is disposed perpendicularly to the surface of the insulating film 2. As another example, in FIG. 9, one end of the elastic suspension component 5 can be connected to a fixed position such as the shell of the sound production unit, and the other end is connected to the insulating film 2 and forms a certain angle with the surface of the insulating film 2. In this way, the elastic suspension component 5 can not only provide a force in the vertical direction, but also provide a force in the horizontal direction (the length or width direction of the insulating film), for example, the X direction in FIG. 10 is the horizontal direction. The vertical force can help the diaphragm film return to the center position, and the horizontal force can keep the diaphragm film in a certain tension at all times. As another example, as shown in FIG. 10, the setting direction of the elastic suspension component 5 is the same as the length or width direction (X direction in FIG. 10) of the insulating film 2, and one end of the elastic suspension component 5 may be connected to the surface of the insulating film 2 or to the side of the insulating film 2.

Referring to FIG. 14, in another example provided in the present disclosure, a connection part 27 is provided on the insulating film 2 or a diaphragm film formed by the insulating film 2 and the conductor 3, and the elastic suspension component 5 is connected to the insulating film 2 or the diaphragm film via the connection part 27. In a specific embodiment, the connection part 27 is a connection hole, and the elastic piece is connected through the connection hole, so that the diaphragm film is suspended at the middle position of the opposing gap.

Referring to FIGS. 1 to 4, in another embodiment provided in the present disclosure, in order to make the connection of the insulating film 2 more stable, two sides of the insulating film 2 are provided with the elastic suspension component 5. Specifically, the elastic suspension component 5 includes two groups of elastic suspension components 5 symmetrically arranged on two sides of the insulating film 2, one end of different groups of elastic suspension components 5 are respectively connected to the first surface and the second surface of the insulating film 2, and the other end is respectively connected to different magnets 1, or connected to the shell 4 connected to the magnet 1. In order to ensure the stability of the connection between the elastic suspension component 5 and the insulating film 2, the elastic suspension component 5 can be connected to the force reinforcement structure, more specifically, connected to the intersection node of the transverse rib group and the longitudinal rib group.

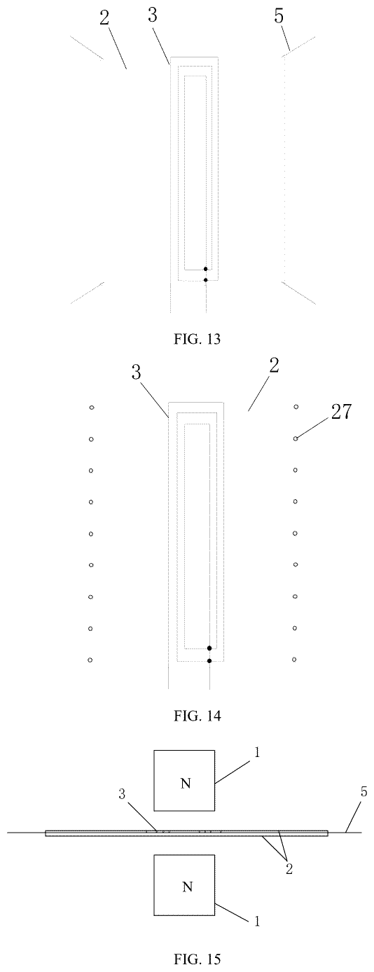

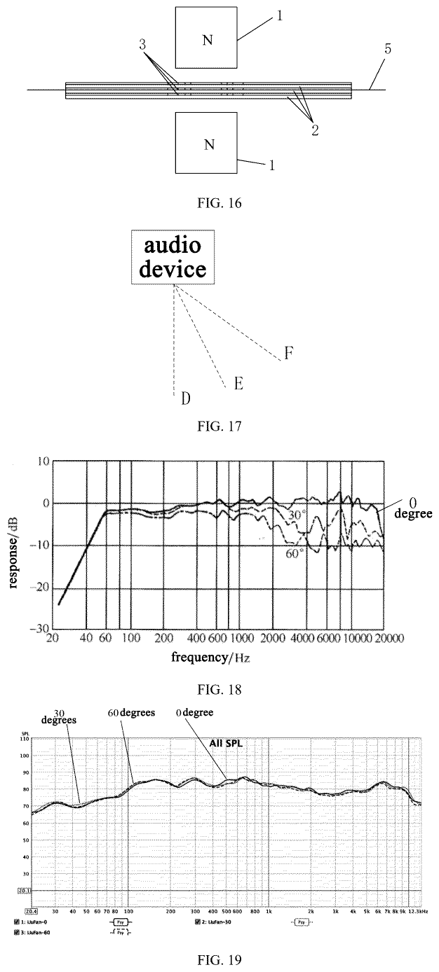

Further, referring to FIGS. 11 to 13, the elastic suspension component 5 includes a plurality of elastic pieces, and the plurality of elastic pieces are arranged along the length direction of the insulating film 2. Alternatively, a plurality of elastic pieces is provided at the four corners of the insulating film 2. Specifically, referring to FIG. 11 and FIG. 12, on two sides of the insulating film 2, a plurality of elastic pieces is connected to the insulating film 2, and the plurality of elastic pieces may be arranged at intervals or in a zigzag arrangement. As another example, referring to FIG. 13, elastic pieces are provided at the four corners of the insulating film 2. As to whether the elastic piece is arranged at a certain angle to the insulating film 2, it can be implemented according to the technical solution in FIG. 8, or according to the technical solution in FIG. 9 or FIG. 10.

In one embodiment provided in the present disclosure, the elastic piece includes one of a linear structure, an M-shaped structure, a V-shaped structure, a C-shaped structure, an arc-shaped structure, a wavy structure, a serrated structure, a spiral linear structure and a ring-shaped structure. For example, referring to FIG. 1 and FIG. 2, the elastic suspension component 5 is a linear structure, and different elastic suspension parts are distributed on different sides of the insulating film 2, thereby providing the insulating film 2 with elastic forces in two different directions, so that the insulating film 2 can return to its initial position after the vibration is completed. As shown in FIG. 2, from the left view of the sound production unit, different linear elastic suspension pieces are arranged in a V-shaped structure, one end of the elastic suspension piece is connected to the longitudinal rib group, and is connected to different longitudinal ribs 23 through multiple groups of elastic suspension components 5. When the insulating film 2 is displaced, the multiple groups of elastic suspension components 5 can make the force on the insulating film 2 more uniform, effectively reducing inertial jitter. Referring to FIG. 7, the elastic suspension component 5 is a sawtooth structure, and two ends of each elastic suspension component are connected to the shell 4 and the insulating film 2 respectively.

Furthermore, the elastic suspension component 5 includes but is not limited to: carbon fiber wire, rubber, elastic metal wire, spring, spandex wire, etc. In the technical solution provided in the present disclosure, the elastic suspension component may also be a supporting structure formed by bending the insulating film 2 or the diaphragm film. Specifically, a strip-shaped support structure with one end connected to the insulating film 2 is formed by cutting at the edge of the insulating film 2, and the support structure extends above or below the insulating film 2 after bending, and the end of the support structure is connected to the magnet or the shell of the sound production unit. So that the diaphragm film is supported or suspended in the middle position of the opposing gap. Furthermore, the support structure is bent to form structures including but not limited to C-shaped, Z-shaped, and M-shaped structures, so that the support structure has elasticity.

Referring to FIGS. 5 and 8, in one embodiment provided in the present disclosure, the sound production unit includes two pairs of magnets 1, an insulating film 2 and a conductor 3. The N poles of the first pair of magnets 1 are arranged opposite to each other with the same poles, and the S poles of the second pair of magnets 1 are arranged opposite to each other with the same poles, and an opposing gap is formed between each pair of magnets 1. The insulating film 2 is passed through the opposing gaps between the two pairs of magnets 1, and the conductor 3 is arranged on the part of the insulating film located in the opposing gap, where the conductor 3 includes a first conductor and a second conductor. Specifically, as shown in FIG. 8, the first conductor is disposed between the magnet groups with N poles facing each other, and the second conductor is disposed between the magnet groups with S poles facing each other, and then the first conductor and the second conductor are connected in series or in parallel. Of course, the first conductor and the second conductor may also be connected as an integral structure. Similarly, the conductor 3 includes multiple sections of main circuits 31 and multiple sections of connection circuits 32. This embodiment is similar to the conductor 3 described in the above embodiment, and will not be described in detail here.

Referring to FIGS. 1 to 12, in one embodiment provided in the present disclosure, a sound production unit includes at least one pair of magnets 1, an insulating film 2 and a conductor 3. Each pair of magnets 1 is disposed opposite to each other with the same poles, and there is an opposing gap between each pair of magnets 1. The insulating film 2 is inserted into the opposing gap, and each pair of magnets 1 is symmetrically distributed on both sides of the insulating film 2. The conductor is disposed on the insulating film 2 and is a disk-shaped conductive circuit surrounding the opposing magnet. Specifically, referring to FIG. 14, the diaphragm film as a whole is composed of an inner butyl film and outer aluminum films on two sides. The outer aluminum film circuit portion is engraved according to the design using laser engraving technology to form a conductor 3, while the remaining non-conductive portion forms an insulating film 2. The conductor 3 is an active sound production part of the sound production unit, and the insulating film 2 is a passive sound production part. When the conductor 3 vibrates at a high frequency, the active sound production part vibrates and generates sound. When the conductor 3 vibrates at a low frequency, the active sound production part drives the passive sound production part to vibrate and produce sound.

Specifically, when current passes through the conductor 3, the diaphragm film in the corresponding area vibrates, and at the same time drives the surrounding insulating film 2 to vibrate. When the vibration frequency is lower, the area of the insulating film 2 driven by the vibration of the conductor 3 is larger, and when the vibration frequency is higher, the area of the insulating film 2 driven by the vibration of the conductor 3 is smaller. In one case, such as when vibrating below a certain frequency, the conductor 3 can drive the entire diaphragm film to vibrate, while when vibrating above a certain frequency, the insulating film 2 is not driven by the conductor 3 at all. In another case, at the same frequency, the area of the insulating film 2 driven by the conductor 3 is determined by the following factors that may affect it: the ability of the diaphragm film to maintain flatness (which can be understood as hardness), the weight of the insulating film 2, the bonding method between the conductor 3 and the insulating film 2, etc. It can be understood that the harder the diaphragm film is, the larger the area of the insulating film 2 that can be driven by the vibration of the conductor 3 is, the tighter the bonding between the conductor 3 and the insulating film 2 is, the larger the area of the insulating film 2 that can be driven by the vibration of the conductor 3 is, the lighter the weight of the insulating film 2 is, the larger the area of the insulating film 2 that can be driven by the vibration of the conductor 3 is.

The multi-layer insulating film 2 and the multi-layer conductor 3 are laminated and bonded to form an integral body, and the conductive circuits located in different layers are electrically connected to each other.

Referring to FIGS. 1 to 13, in one embodiment provided in the present disclosure, the sound production unit further includes an elastic suspension component 5. One end of the elastic suspension component 5 is connected to the insulating film 2, and the other end is connected to the magnet 1 or the shell of the sound production unit. The elastic suspension component 5 is always in a state of tension or compression, and the elastic force generated by it can not only make the insulating film hang in the middle position of the opposing gap, but also make the diaphragm film quickly return to the middle position after vibration.

Furthermore, the elastic suspension component 5 is connected to the first surface of the insulating film 2. Alternatively, the first surface and the second surface of the insulating film 2 are both connected to the elastic suspension component 5. The elastic suspension component 5 is connected to two sides of the insulating film 2 or the conductor 3 respectively. Alternatively, the insulating film 2 or the conductor 3 is connected to elastic suspension component 5 on all sides.

For more specific embodiments of the elastic suspension component 5, reference may be made to the elastic suspension component 5 described in other embodiments above, which will not be described in detail here.

Referring to FIG. 14, in one embodiment provided in the present disclosure, a connection part 27 is provided on the diaphragm film formed by connecting the insulating film 2 and the conductor 3, and the elastic suspension component 5 is connected to the diaphragm film via the connection part 27. Specifically, the connection part 27 is disposed at the edge of the diaphragm film, that is, it can be disposed at the edges of two sides of the diaphragm film, or it can be disposed at the edges of all four sides of the diaphragm film. In a specific embodiment, the connection part 27 is a through hole, and the number of the through holes can be set according to the length or width of the diaphragm film, which is not specifically limited. One end of the elastic piece in the elastic suspension component 5 is connected to the through hole, and the other end is connected to the magnet 1 or the shell of the sound production unit. Thereby, the diaphragm film is suspended in the middle position of the opposing gap, and an elastic force is provided to the diaphragm film so that the diaphragm film can quickly return to the middle position after vibration.

In another embodiment of the present disclosure, an audio device is provided, including a shell and the above-mentioned sound production unit, where the sound production unit is arranged on the shell. The audio device includes but is not limited to a headphone, an amplifier, a speaker, etc. Said elastic suspension component can be connected to the shell of the audio device in addition to being connected to the magnet or the shell of the sound production unit. In addition, the implementation method of the sound production unit can refer to and draw on the contents of the above embodiments, which will not be described in detail here.

When traditional audio device produces sound through the vibration of a paper cone or a whole film, it is a surface sound source. The sound emitted by a surface sound source has a strong axiality, that is, the greater the angle from the axis of the sound production surface, the more the high-frequency sound is attenuated. Referring to FIG. 17, the direction of straight line D is the direction of the axis of the sound production surface, the direction of straight line E is the direction forming an angle of 30 degrees with the axis of the sound production surface, and the direction of straight line F is the direction forming an angle of 60 degrees with the axis of the sound production surface. Referring to FIG. 18, the three curves in the figure are frequency response curves at different angles to the axis of the sound production surface. It can be seen from the figure that, relative to the frequency response curve in the direction of the axis of the sound production surface (0 degree direction), the frequency response curve in the direction at an angle of 60 degrees to the axis of the sound production surface has a greater attenuation of the sound pressure level in the high-frequency band than the frequency response curve in the direction at an angle of 30 degrees to the axis of the sound production surface. In addition, as the angle increases, the attenuation of the sound pressure level in the high-frequency band will be even greater.

However, in the technical solution provided in the present disclosure, the conductive circuit is arranged on a small area of the insulating film. When the conductive circuit is energized and vibrates at a high frequency, the conductor 3 can be roughly considered as a line when it vibrates. When a line vibrates and makes sound, a line sound source is formed. The radiated sound can be evenly distributed on the cylindrical surface with the line sound source as the axis. In this way, the problem of sound pressure level attenuation of high-frequency sound at different angles is eliminated, thereby realizing 360-degree omnidirectional audio device. Specifically, referring to FIG. 19, the three curves in the figure are frequency response curves of sound at different angles to the central axis of the audio device. It can be seen from the figure that the frequency response curves obtained at different angles, whether in the case of high frequency, medium frequency or low frequency, the three frequency response curves roughly overlap. Therefore, when the user is at different angles around the audio device, the sound pressure levels of the sounds in each audio band heard by the user are the same as the sound pressure levels of the sounds heard when facing the audio device directly (in the axial direction).

The technical solution provided in the embodiment of the present disclosure, by setting a rib structure on the insulating film, allows the conductor to drive a smaller area or even no insulation film to vibrate during high-frequency vibration, and drive a larger area or even the entire insulation film to vibrate during low-frequency vibration, thereby providing partial gain compensation for low-frequency sounds and ensuring that the sound pressure level of the sound production unit is stable over the entire sound range when emitting low-frequency and high-frequency sounds. In addition, by providing an elastic suspension component, it can not only fix the diaphragm film, but also assist the diaphragm film to return to its original position after vibration is completed, thereby effectively ensuring the sound effect of the diaphragm film.

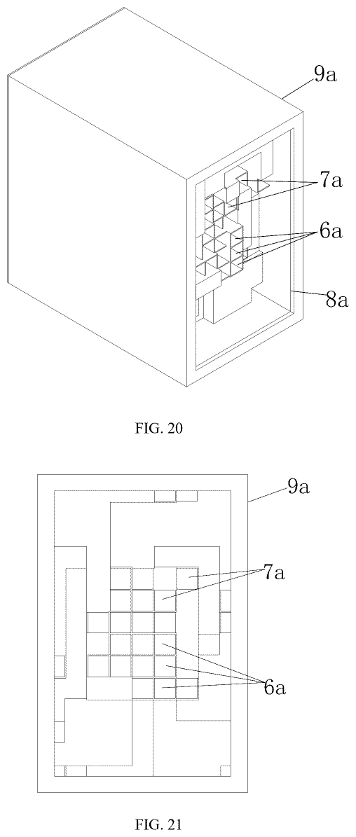

FIG. 20 is a schematic diagram of the three-dimensional structure of an audio shell provided in an embodiment of the present disclosure; FIG. 21 is a front view of an audio shell provided in an embodiment of the present disclosure. Referring to FIGS. 20 and 21, in one embodiment of the present disclosure, an audio box is provided, which includes: a shell 9a, a sound production unit, and an inverted tube component 6a. The shell 9a has an inner cavity with an opening; the opening of the shell 9a is provided with a sound production unit, with one side of the diaphragm film of the sound production unit facing the inner cavity. The sound production unit can be an integral structure with the shell 9a, or it can be connected to the opening 8a of the shell 9a by a fastener. The sound production unit produces sound through the vibration of the diaphragm film. The diaphragm film vibrates back and forth during the vibration process, thereby generating forward sound waves and reverse sound waves. The phase difference between the forward sound waves and the reverse sound waves is 180 degrees.

In the prior art, by designing an inverted hole, a reverse sound wave of a certain frequency can be inverted. In order to make full use of the reverse sound wave, the audio device provided in the present disclosure includes an inverted tube component 6a. The inverted tube component 6a is arranged in the inner cavity, with a first end facing the opening of the inner cavity and a second end communicating with the outside of the shell, and an echo hole 62a is formed on one side surface of the shell 9a. Specifically, the inverted tube component 6a is a hollow tubular structure with openings at two ends. When a sound wave enters from one end of the inverted tube component 6a, it can be transmitted from the other end of the inverted tube component 6a. During the propagation process in the inverted tube component 6a, the phase of the sound wave changes by 180 degrees, so that the phase of the reverse sound wave of the corresponding frequency transmitted from the other end of the inverted tube component 6a is the same as the phase of the forward sound wave emitted by the diaphragm film. According to the design, the inverted tube 61a in the inverted tube component 6a can have different lengths. When the sound enters the tube, the sound waves of different frequency bands will selectively prefer to enter the tubes of different lengths. In this way, the reverse sound waves of multiple frequencies can be superimposed with the forward sound waves of the corresponding frequency bands after inversion, and finally the energy of the forward sound waves of multiple frequencies is enhanced, thereby improving the intensity of the sound waves with a wider frequency, and at the same time reducing to a certain extent the problem of sound distortion caused by the poor absorption of the reverse sound waves by the cabinet. It should be noted that the other side of the shell 9a may be a side opposite to the front surface of the opening, or may be a side adjacent to the shell 9a. For example, the sound production unit is disposed on the front side of the shell, and the echo hole 62a is disposed on the rear side of the shell. Alternatively, the sound production unit and the echo hole 62a are arranged on two adjacent surfaces of the shell.

Furthermore, the sound production unit and the echo hole 62a can also be arranged on the same side of the shell 9a. For example, the sound production unit and the echo hole 62a are both arranged on the front surface of the shell 9a, the sound production unit is arranged on the upper half of the front surface, and the echo hole 62a is arranged on the lower half of the front surface.

In another embodiment of the present disclosure, an audio box is provided. The audio box includes: a shell 9a, a sound production unit, and a closed tube component 7a. Referring to FIG. 22, the closed tube component 7a has a first open end and a second closed end, the first open end faces the diaphragm film, and the second closed end is disposed in the inner cavity. The closed tube component 7a is a hollow tubular structure with one end open and the other end closed. The reverse sound wave can enter the closed tube component 7a from the open end and be absorbed by the closed tube component 7a. According to the design, the closed tube 71a in the closed tube component 7a has different lengths. The reverse sound waves of different frequency bands can selectively enter the closed tubes of different lengths. The closed tube component 7a can absorb this part of the sound waves, thereby making the frequency response curve of the audio more stable and greatly reducing the distortion of the audio.

The following is a more vivid introduction to the working principle of the closed tube component. Specifically, after the reverse sound wave enters the audio box, the air in the audio box will be compressed under the action of the sound wave. At this time, the compressed air will generate a reverse thrust on the diaphragm film. In this case, the vibration amplitude of the diaphragm film will be weakened, which will directly lead to a decrease in the sound pressure level of the forward sound wave. To solve these problems, traditional speakers solve the problem by increasing the size of the audio box, but the bass that usually has the greatest impact requires a very large volume to be better absorbed. In a technical solution provided in the present disclosure, through the effect of a closed tube component, closed tubes of different lengths are designed so that sound selectively enters the closed tube component. Closed tubes of different lengths can absorb sound waves of different frequencies. When the closed tube absorbs reverse sound waves of some frequencies, the sound pressure level loss of the forward sound wave corresponding to the frequency band of the reverse sound wave becomes smaller, and the frequency response curve state of the audio system also tends to be stable.

In addition, the reverse sound wave vibration in the audio box will produce noise. If the noise is not eliminated, the sound produced by the audio device will be distorted. Through the action of multiple closed tubes, it can absorb wide-band noise, thereby effectively reducing sound distortion and ensuring good sound effects of high-fidelity audio.

In combination with the above embodiments, in one embodiment provided in the present disclosure, the audio box includes: a shell 9a, a sound production unit, an inverted tube component 6a and a closed tube component 7a. According to the design, when the diaphragm film vibrates to generate sound, reverse sound waves of different frequency bands will selectively enter the inverted tube component 6a, and reverse sound waves of other different frequency bands will enter the closed tube component 7a. The inverted tube component 6a inverts the sound waves of the corresponding frequency band and superimposes them with the forward sound waves. The closed tube component 7a will absorb sound waves in the corresponding frequency band. The frequency bands of the sound waves entering the inverted tube component 6a and the closed tube component 7a are different from each other. Thus, the inverted tube component 6a and the closed tube component 7a can cover a wider frequency of sound waves, making the frequency response curve of the sound waves more stable.

It can be understood that the inverted tube component 6a can generate gain for a wider bass frequency band according to the design, while the closed tube component 7a can increase the absorption of reverse sound waves, thereby improving the sound pressure level of the forward sound waves, so that the mid-bass part can have a better sound pressure level performance, greatly improving the sound distortion while reducing the volume of the audio box, so that the audio can break free from the limitations of large space and be applied in a wider range of fields.

Furthermore, the front side of the diaphragm film of the sound production unit faces the outside of the shell 9a (the spatial direction where the user is located), and the forward sound waves generated by the diaphragm film diffuse out of the sound cavity and are heard by the user. Part of the reverse sound wave generated by the diaphragm film selectively diffuses into the inverted tube component 6a, and another part selectively diffuses into the closed tube component 7a, and the reverse sound wave entering the inverted tube component is radiated from the echo hole 62a. Specifically, the opening at one end of the inverted tube component 6a and the opening of the closed tube component 7a are respectively facing the back side of the diaphragm film. When a reverse sound wave is generated on the back side of the diaphragm film, sound waves of different frequency bands of the reverse sound wave will selectively enter the inverted tube component 6a and the closed tube component 7a. Part of the sound waves are absorbed by the closed tube component 7a, and the other part of the sound waves pass through the inverted tube component 6a. During the propagation process, a 180-degree phase inversion occurs and the sound waves are finally transmitted from the echo hole 62a (the other end open of the inverted tube component).

In the existing technology, in order to reduce the negative effect of reverse sound waves on the sound pressure level of forward sound waves and reduce sound distortion, the usual solution is to set sound-absorbing cotton in the cavity of the speaker to absorb the reverse sound waves. However, on the one hand, the sound-absorbing cotton can only absorb high-frequency sound waves and cannot absorb medium and low frequencies well. On the other hand, the box volume required to absorb reverse sound waves is relatively large. This type of speaker cannot adapt to some miniaturized usage scenarios, such as car audio. To solve the above problem, in an embodiment provided in the present disclosure, the inverted tube component 6a may include one inverted tube 61a or may include multiple inverted tubes 61a. In one embodiment, the inverted tube component 6a includes a plurality of inverted tubes 61a. The inverted tubes 61a may have different lengths according to the design. The inverted tubes 61a of different lengths can perform phase inversion on sound waves of different frequency bands. The sounds of different frequency bands will selectively pass through the inverted tubes 61a of different lengths, so that the phases of the sound waves of different frequency bands are changed to the original 180 degrees. The first end opens of the multiple inverted tubes 61a are all toward the diaphragm film, and the other ends extend to the other side of the shell 9a, and the second end opens of the multiple inverted tubes 61a form a plurality of echo holes 62a on the surface of the shell 9a.

When the diaphragm film vibrates and makes sound, the reverse sound waves generated on the back of the diaphragm film can enter the inverted tube 61a. Inverted tubes 61a of different lengths can invert sound waves of different frequency bands. After the inversion is completed, they are transmitted out from the echo hole 62a. At this time, the phase of the sound waves of different frequency bands is the same as the phase of the forward sound wave. The reverse sound waves after inversion can be superimposed on the forward sound waves, and the energy of the forward sound waves is enhanced, thereby improving the sound intensity.

Furthermore, in order to meet the needs of customized audio or audio with special functions, this can be achieved by changing the lengths of different inverted tubes 61a. Specifically, the inverted tubes 61a of different lengths can invert sound waves of different frequency bands. By arranging the inverted tubes 61a of different lengths in the shell of the speaker, bass sound waves of different frequency bands can selectively enter different inverted tubes 61a. These inverted tubes 61a can invert the sound waves of different frequency bands of low-frequency sounds, thereby enhancing the bass effect of the audio device.

Through the action of the multiple inverted tubes 61a, the sound wave bass effect of the audio device in the low frequency band is enhanced, and the frequency response curve of the audio device also becomes stable. In the technical solution provided in the present disclosure, there is no specific limitation on the inversion frequencies of different inverted tubes 61a, and inverted tubes 61a of different lengths can be designed according to actual conditions.

Furthermore, the closed tube component 7a may include one closed tube 71a or may include a plurality of closed tubes 71a. In a specific embodiment, the audio box includes a plurality of closed tubes 71a, and different closed tubes 71a have different lengths. The closed tube 71a extends from the opening of the inner cavity to the other side of the shell. Alternatively, the closed tube 71a extends from the opening of the inner cavity to the other side of the shell in a reciprocating bending shape, and the other end of the closed tube 71a is in the inner cavity of the shell. By design, closed tubes 71a of different lengths can absorb sound waves in different specific frequency bands. When the diaphragm film vibrates to generate reverse sound waves, low-frequency sounds or medium-frequency sounds of different frequencies in the reverse sound waves will selectively enter different closed tubes 71a. For example, when there is a sound production unit itself, as the frequency decreases below 1000 Hz, the frequency response curve also decreases, which results in poor mid-bass of the sound, poor sense of impact and wrapping of the sound, and unsatisfactory distortion of the final sound effect. In a specific embodiment provided in the present disclosure, by reasonably selecting 42 frequencies of reverse sound waves between 80 Hz-1000 Hz for absorption, the size and length of these 42 closed tubes are obtained by calculation, thereby increasing the sound pressure level of 80 Hz-1000 Hz, and making the frequency response curve approach a stable state. Specifically, the frequencies corresponding to the reverse sound waves absorbed by the 42 closed tubes are different. Although a closed tube can only absorb sound waves of a single frequency, with the action of multiple closed tubes, the ups and downs of the frequency response curve of the sound waves become more gentle. It can be roughly considered that multiple inverted tubes work together to invert the sound waves in the frequency range of 80 Hz-1000 Hz. From a macro perspective, the entire frequency response curve approaches a stable state.

In another embodiment provided in the present disclosure, a plurality of inverted tubes 61a and a plurality of closed tubes 71a are respectively arranged in the shell of the speaker. The inverted tubes 61a of different lengths can invert low-frequency sound waves of different frequencies, thereby producing a gain effect on the low-frequency sound and making the frequency response curve of the speaker smooth. In addition, different closed tubes 71a can absorb sound waves of other frequencies (mid-frequency band and low-frequency band). Ultimately, the frequency response curve of sound waves in all frequency bands of the audio device is smoother, reducing audio distortion.

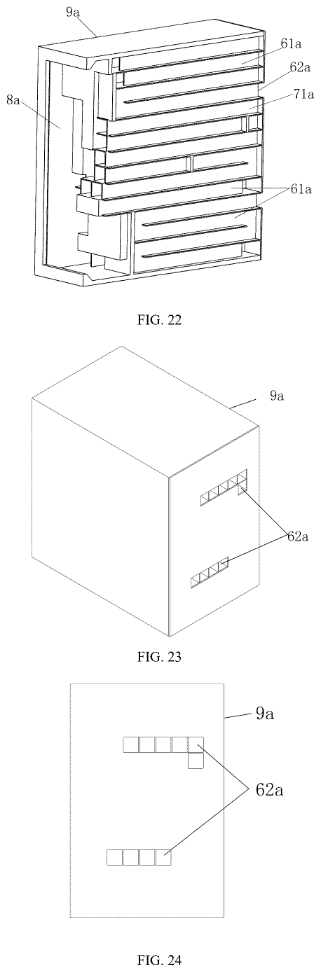

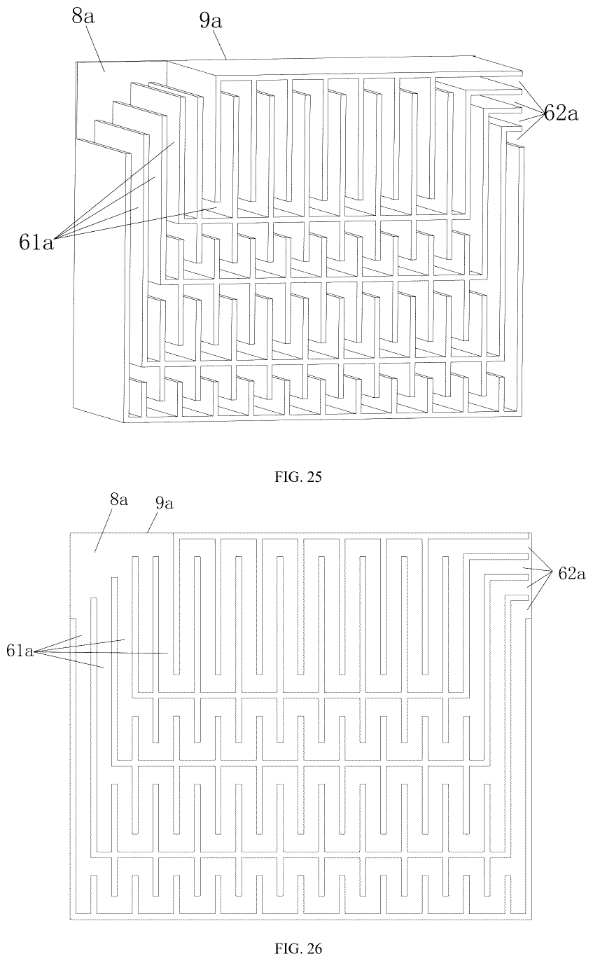

In a specific embodiment, as shown in FIG. 20, the open ends of the multiple inverted tubes 61a and the multiple closed tubes 71a face the opening of the inner cavity. In the technical solution of the present disclosure, there is no specific limitation on the number of the inverted tubes 61a and the closed tubes 71a and they can be set according to actual conditions. The plurality of inverted tubes 61a may be included alone, or the plurality of inverted tubes 61a may be included alone, or the plurality of inverted tubes 61a and the plurality of closed tubes 71a may be included at the same time. Referring to FIGS. 21 and 22, the cross-sectional shape of the plurality of inverted tubes 61a and the plurality of closed tubes 71a is square, the tube walls of different tubes are stacked on each other, and are an integral structure with the shell 9a of the audio device. Further referring to FIG. 23 and FIG. 24, a plurality of inverted tubes 61a extend to the surface of the rear side of the shell 9a (the shell 9a is open to the front side), and a plurality of echo holes 62a are formed on the surface of the shell 9a.

Referring to FIGS. 25 and 26, in another embodiment provided in the present disclosure, four inverted tubes 61a are provided in the cavity of the audio device. The lengths of the four inverted tubes 61a are different. Different inverted tubes 61a can invert low-frequency sounds of different frequencies. The other open ends of the four inverted tubes 61a extend to the other side of the shell 9a, and four echo holes 62a are formed on the surface of the shell 9a. Through the action of the multiple inverted tubes 61a, sound waves of corresponding frequencies will selectively enter different inverted tubes 61a. Inverted tubes 61a of different lengths can invert the sound waves of corresponding frequencies, thereby enhancing the low-frequency performance of the audio.

Furthermore, in an embodiment provided in the present disclosure, referring to FIG. 22, when the length of the shell 9a of the audio device is relatively short, the inverted tube 61a extends directly from the opening 8a of the inner cavity to the other side of the shell 9a in a straight line. When the size of the inverted tube 61a is longer, the inverted tube 61a is reciprocatingly bent in the inner cavity and extends from the opening of the inner cavity to the other side of the shell 9a. By making the inverted tube 61a bend back and forth, it is possible to arrange the inverted tubes 61a of different lengths in an inner cavity with a limited volume. For example, the number of reciprocating bends of the longer inverted tube 61a is greater than that of the shorter inverted tube 61a. For example, in one kind of audio device, three inverted tubes are provided, the length of the first inverted tube is 260 mm, the length of the second inverted tube is 698 mm, and the length of the third inverted tube is 1150 mm. Since the length of the audio box is limited, the inverted tube 61a that is too long needs to be spiraled or reciprocally bent and stacked in the audio box. That is, the number of reciprocating bends of the third inverted tube is greater than that of the first inverted tube and the second inverted tube. In addition, by properly arranging multiple tube paths, the utilization rate of the inner cavity of the audio box can be improved, thereby realizing the design of miniaturized audio device. For example, by using 3D printing technology, a shell 9 a having an inverted tube 61a and a closed tube 71a with a complex tube path can be printed, so that the audio device can be used on small devices such as mobile phones, headphones, computers and televisions.

Furthermore, in an embodiment provided in the present disclosure, the cross-sectional shape of the inverted tube 61a is the same as the cross-sectional shape of the closed tube 71a. The cross-sectional shapes include but are not limited to: square, circular, triangular and multi-shaped. Alternatively, the cross-sectional shapes of the plurality of inverted tubes 61a may include at least two different cross-sectional shapes, and different inverted tubes 61a may have different cross-sectional shapes. Likewise, the cross-sectional shapes of the plurality of closed tubes 71a include at least two different cross-sectional shapes, and different closed tubes 71a have different cross-sectional shapes. For example, the cross-sectional shape of the inverted tube 61a and the cross-sectional shape of the closed tube 71a are both square, or the cross-sectional shape of the inverted tube 61a is circular, and the cross-sectional shape of the closed tube 71a is square.

Referring to FIG. 20, in one embodiment of the present disclosure, an audio device is also provided. The audio unit includes the above-mentioned audio box and at least one sound production unit. The sound production unit is arranged at the opening of the shell 9a. The sound production unit is spaced apart from the inverted tube component 6a. A sound guide cavity is formed between the inverted tube component 6a and the sound production unit. A sound guide cavity is formed by arranging the sound production unit and the inverted tube component 6a at a certain distance. After the diaphragm film of the sound production unit vibrates and produces sound, the reverse sound wave will pass through the sound guide cavity and enter the inverted tube component 6a and the closed tube component 7a. Through the action of the sound guide cavity, the reverse sound wave can fully diffuse in the sound guide cavity and selectively enter the inverted tube component 6a and the closed tube component 7a at different positions. The inverted tube component 6a can perform phase inversion on low-frequency sounds of different frequency bands, thereby bringing a gain effect to the low-frequency sounds of different frequency bands. Specifically, the inverted tube component 6a includes a plurality of inverted tubes 61a. Different inverted tubes 61a have different lengths. Different inverted tubes 61a can perform inversion on low-frequency sounds of different frequencies. In addition, the closed tubes 71a of different lengths in the closed tube component 7a can absorb other different medium and low frequency sound waves. Through the combined effect of the inverted tube component 6a and the closed tube component 7a, the frequency response curve of the audio device is closer to a stable state, reducing the sound distortion of the audio device.

It should be noted that the audio device proposed in the present disclosure is not only applicable to small devices, such as headphones, mobile phone speakers, car audio and TV speakers, but also to medium and large devices, such as professional large audio and home audio. In addition, the above-mentioned sound production units include but are not limited to: vibration speakers, ribbon speakers, etc. As long as the speakers can produce sound through vibration and generate forward sound waves and reverse sound waves, they can be used in the audio box proposed in the present disclosure.

In another embodiment of the present disclosure, an audio system is provided, including a controller and a plurality of the above-mentioned audio devices, where the controller is electrically connected to the plurality of audio devices respectively. The controller is used to control the sound of multiple audio devices. When the controller outputs different sound signals, the pronunciation effects of different audio devices will be different. Specifically, the audio device may be a tweeter, a bass speaker, or a mixed sound speaker. The implementation method of the pronunciation unit can refer to and draw on the contents of the above embodiments, which will not be described in detail here.

In summary, in the technical solution provided in the embodiment of the present disclosure, by arranging an inverted tube component and a closed tube component in the sound cavity, the multiple inverted tubes in the inverted tube component can invert sound waves of multiple frequencies, so that the phase of the reverse sound wave is the same as the phase of the forward sound wave. The multiple closed tubes in the closed tube component can absorb part of the sound waves of multiple frequencies in the reverse sound waves, thereby reducing the problem of reduced sound pressure level caused by the cancellation of the reverse sound waves and the forward sound waves, making the sound effect of the audio device better. Through the action of the inverted tube component and the closed tube component, the frequency response curve of the audio device will be closer to a stable state, while reducing the distortion of the audio.

Finally, it should be noted that the above embodiments are only used to illustrate the technical solutions of the present disclosure, rather than to limit it. Although the present disclosure has been described in detail with reference to the aforementioned embodiments, those skilled in the art should understand that they can still modify the technical solutions described in the aforementioned embodiments, or make equivalent replacements for some of the technical features therein. However, these modifications or replacements do not deviate the essence of the corresponding technical solutions from the spirit and scope of the technical solutions of the embodiments of the present disclosure.

1. A sound production unit, comprising:
at least one pair of magnets, wherein each pair of magnets are arranged opposite to each other with the same poles, and there is an opposing gap between each pair of magnets;
an insulating film, inserted into the opposing gap, wherein each pair of magnets are symmetrically distributed on two sides of the insulating film;
a conductor, arranged on the insulating film and located in the opposing gap;
wherein, when the conductor vibrates at a high frequency, the conductor vibrates and produces sound; when the conductor vibrates at a low frequency, the conductor drives the entire insulating film to vibrate and produce sound.

2. The sound production unit according to claim 1, wherein the conductor is bonded to the insulating film by gluing;
the conductor is bonded to a first surface of the insulating film;
or, different conductors are bonded to a first surface and a second surface of the insulating film respectively.

3. The sound production unit according to claim 2, wherein multiple layers of the insulating films and multiple layers of the conductors are laminated and bonded to form a whole, and the conductors located in different layers are electrically connected to each other.

4. The sound production unit according to claim 1, further comprising a rib structure;
wherein the rib structure is penetrated on the insulating film and is used to drive the insulating film to vibrate together when the conductor vibrates.

5. The sound production unit according to claim 4, wherein the rib structure comprises: a rib group extending in at least one direction;
the rib group comprises a plurality of ribs arranged at intervals.

6. The sound production unit according to claim 5, wherein the rib comprises one of carbon fiber material, metal material, plastic material, wood material, and polymer material.

7. The sound production unit according to claim 5, wherein the rib is a convex rib structure formed by bending the insulating film;
or, the rib structure is integrally formed on the insulating film when the insulating film is prepared.

8. The sound production unit according to claim 1, wherein the conductor is a conductive wire;
or, the conductor is a conductive film.

9. The sound production unit according to claim 1, further comprising an elastic suspension component, one end of the elastic suspension component is connected to the insulating film, and the other end is connected to the magnet or a shell of the sound production unit.

10. The sound production unit according to claim 9, wherein the elastic suspension component is arranged on one side of the insulating film;
or, the two sides of the insulating film are provided with the elastic suspension component.

11. The sound production unit according to claim 10, wherein the elastic suspension component comprises a plurality of elastic pieces, and the plurality of elastic pieces are arranged along a length direction of the insulating film;
or, the plurality of elastic pieces is arranged at four corners of the insulating film.

12. The sound production unit according to claim 11, wherein the elastic piece comprises one of a linear structure, an M-shaped structure, a V-shaped structure, a C-shaped structure, an arc structure, a wavy structure, a sawtooth structure, a spiral linear structure and a ring structure.

13. A sound production unit, comprising:
at least one pair of magnets, wherein each pair of magnets are arranged opposite to each other with the same poles, and there is an opposing gap between each pair of magnets;
an insulating film, inserted into the opposing gap, wherein each pair of magnets are symmetrically distributed on two sides of the insulating film;
a conductor, arranged on the insulating film to form a diaphragm film, wherein the conductor is located in the opposing gap;
wherein, the conductor is an active sound production part of the sound production unit; when current flows through the conductor, the active sound production part drives the insulating film to vibrate and produce sound.

14. The sound production unit according to claim 13, wherein the conductor is bonded to a first surface of the insulating film;
or, different conductors are bonded to a first surface and a second surface of the insulating film respectively;
the conductor is bonded to the insulating film by gluing.

15. The sound production unit according to claim 14, wherein multiple layers of the insulating films and multiple layers of the conductors are laminated and bonded to form a whole, and conductive circuits located in different layers are electrically connected to each other.

16. The sound production unit according to claim 13, further comprising an elastic suspension component, one end of the elastic suspension component is connected to the insulating film, and the other end is connected to the magnet or a shell of the sound production unit.

17. The sound production unit according to claim 16, wherein the elastic suspension component is connected to the first surface of the insulating film;
or, the first surface and the second surface of the insulating film are both connected to the elastic suspension component.

18. The sound production unit according to claim 16, wherein a supporting structure is formed by bending at an edge of the insulating film, and the supporting structure is the elastic suspension component.

19. The sound production unit according to claim 16, wherein the elastic suspension component is connected to two side edges of the insulating film respectively;
or, four side edges of the insulating film are all connected to the elastic suspension component.

20. An audio device, comprising a shell and a sound production unit according to claim 1;
wherein the sound production unit is arranged on the shell.

21-32. (canceled)
